(19) United States
(12) Patent Application Publication
(10) Pub. No.: US 2010/0073499 A1
(43) Pub. Date: Mar. 25, 2010

(54) IMAGE CAPTURE USING SEPARATE LUMINANCE AND CHROMINANCE SENSORS

(75) Inventor: David S. Gere, Palo Alto, CA (US)

Correspondence Address: KRAMER LEVIN NAFTALIS & FRANKEL LLP, 1177 Avenue of the Americas, New York, NY, 10036, US

(73) Assignee: Apple Inc., Cupertino, CA (US)

(21) Appl. No.: 12/238,374

(22) Filed: Sep. 25, 2008

(51) Int. Cl. H04N 5/228

(52) U.S. Cl. 348/222.1; 348/E05.031

(57) ABSTRACT

Systems and methods are provided for capturing images using an image sensing device. In one embodiment, an image sensing device may include a first lens train for sensing a first image and a second lens train for sensing a second image. The image sensing device may also include a first image sensor for capturing the luminance portion of the first image and a second image sensor for capturing the chrominance portion of the second image. The image sensing device may also include an image processing module for combining the luminance portion captured by the first image sensor and the chrominance portion captured by the second image sensor to form a composite image.

### FIELD OF THE INVENTION

This relates to systems and methods for capturing images and, more particularly, to systems and methods for capturing images using separate luminance and chrominance sensors.

### BACKGROUND OF THE DISCLOSURE

The human eye is comprised of rods and cones, where the rods sense luminance and the cones sense color. The density of rods is higher than the density of cones in most parts of the eye. Consequently, the luminance portion of a color image has a greater influence on overall color image quality than the chrominance portion. Therefore, an image sensing device that emphasizes luminance over chrominance is desirable because it mimics the operation of the human eye.

### SUMMARY OF THE DISCLOSURE

Systems and methods for capturing images using an image sensing device are provided. In one embodiment, an image sensing device may include a lens train for sensing an image and a beam splitter for splitting the image sensed by the lens train into a first split image and a second split image. The image sensing device may also include a first image sensor for capturing a luminance portion of the first split image and a second image sensor for capturing a chrominance portion of the second split image, and an image processing module for combining the luminance portion and the chrominance portion to form a composite image.

In another embodiment, an image sensing device may include a first image sensor for capturing a first image, a second image sensor for capturing a second image, and an image processing module. The image processing module may be configured to combine the first image and the second image to form a composite image.

In another embodiment, a method of operating an image sensing device may include generating a high-quality luminance image with a first sensor, generating a chrominance image with the second sensor, and substantially aligning the high-quality luminance image with the chrominance image to form a composite image.

In another embodiment, an image sensing device may include a first lens train for sensing a first image, a second lens train for sensing a second image, and a third lens train for sensing a third image. The image sensing device may also include a red image sensor for capturing the red portion of the first image, a green image sensor for capturing the green portion of the second image, and a blue image sensor for capturing the blue portion of the third image. The image sensing device may also include an image processing module for combining the red portion, the green portion, and the blue portion to form a composite image.

### BRIEF DESCRIPTION OF THE DRAWINGS

The above and other aspects and features of the invention will become more apparent upon consideration of the following detailed description, taken in conjunction with the accompanying drawings, in which like reference characters refer to like parts throughout, and in which:

FIG. 1 is a functional block diagram that illustrates certain components of a system for practicing some embodiments of the invention;

FIG. 2 is a functional block diagram of an image sensing device having a single lens train according to some embodiments of the invention;

FIG. 3 is a functional block diagram of an image sensing device having parallel lens trains according to some embodiments of the invention; and

FIG. 4 is a process diagram of an exemplary method for capturing an image using separate luminance and chrominance sensors according to some embodiments of the invention.

### DETAILED DESCRIPTION OF THE DISCLOSURE

Some embodiments of the invention relate to systems and methods for capturing an image using a dedicated image sensor to capture the luminance of a color image.

In the following discussion of illustrative embodiments, the term “image sensing device” includes, without limitation, any electronic device that can capture still or moving images and can convert or facilitate converting the captured image into digital image data, such as a digital camera. The image sensing device may be hosted in various electronic devices including, but not limited to, personal computers, personal digital assistants (“PDAs”), mobile telephones, or any other devices that can be configured to process image data. The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “based on,” as used in the claims and specification herein, is not exclusive and allows for being based on additional factors that may or may not be described.

It is to be understood that the drawings and descriptions of the invention have been simplified to illustrate elements that are relevant for a clear understanding of the invention while eliminating, for purposes of clarity, other elements. For example, certain hardware elements typically used in an image sensing device, such as photo-sensing pixels on integrated circuit dies or chips, are not described herein. Similarly, certain details of image processing techniques, such as algorithms to correct stereo effects, are not described herein. Those of ordinary skill in the art will recognize and appreciate, however, that these and other elements may be desirable in such an image sensing device. A discussion of such elements is not provided because such elements are well known in the art and because they do not facilitate a better understanding of the invention.

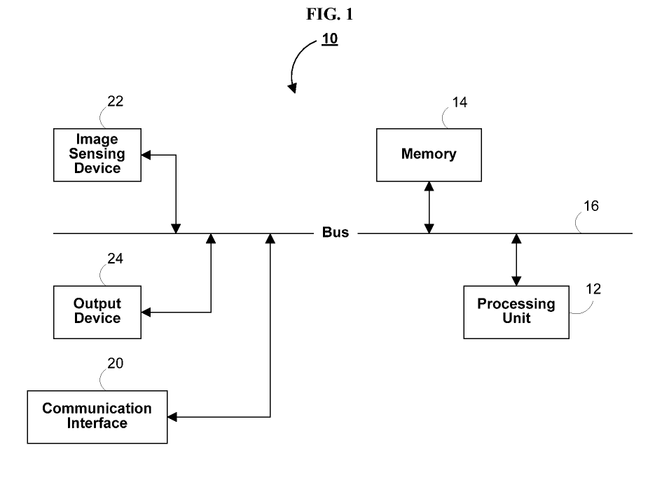

FIG. 1 is a functional block diagram that illustrates the components of an exemplary electronic device 10 that includes an image sensing device 22 according to some embodiments of the invention. Electronic device 10 may include a processing unit 12, a memory 14, a communication interface 20, image sensing device 22, an output device 24, and a system bus 16. System bus 16 may couple two or more system components including, but not limited to, memory 14 and processing unit 12. Processing unit 12 can be any of various available processors and can include multiple processors and/or co-processors.

Image sensing device 22 may receive incoming light and convert it to image signals. Memory 14 may receive the image signals from image sensing device 22. Processing unit 12 may process the image signals, which can include converting the image signals to digital data. Communication interface 20 may facilitate data exchange between electronic device 10 and another device, such as a host computer or server.

Memory 14 may include removable or fixed, volatile or non-volatile, or permanent or re-writable computer storage media. Memory 14 can be any available medium that can be accessed by a general purpose or special purpose computing or image processing device. By way of example, and not limitation, such a computer readable medium can comprise flash memory, random access memory (“RAM”), read only memory (“ROM”), electrically erasable programmable read only memory (“EEPROM”), optical disk storage, magnetic disk storage or other magnetic storage, or any other medium that can be used to store digital information.

It is to be appreciated that FIG. 1 may also describe software that can act as an intermediary between users and the basic resources of electronic device 10. Such software may include an operating system. The operating system, which can be resident in memory 14, may act to control and allocate resources of electronic device 10. System applications may take advantage of the resource management of the operating system through program modules and program data stored in memory 14. Furthermore, it is to be appreciated that the invention can be implemented with various operating systems or combinations of operating systems.

Memory 14 may tangibly embody one or more programs, functions, and/or instructions that can cause one or more components of electronic device 10 (e.g., image sensing device component 22) to operate in a specific and predefined manner as described herein.

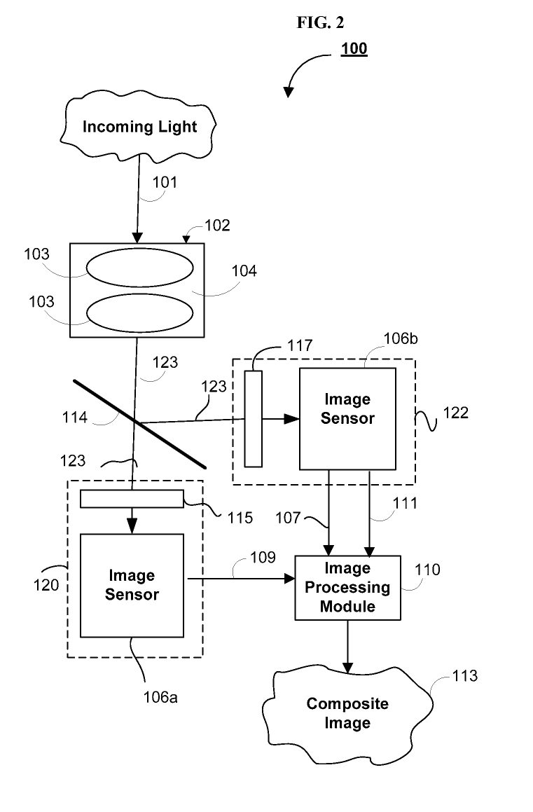

FIG. 2 is a functional block diagram of an exemplary image sensing device 100, which may be similar to image sensing device 22 of FIG. 1, that illustrates some of the components that may capture and store image data according to some embodiments of the invention. Image sensing device 100 may include a lens assembly 102, a beam splitter 114, a filter 115, an image sensor 106a, a filter 117, an image sensor 106b, and an image processing module 110. Lens assembly 102 may include a single lens train 104 with one or more optically aligned lens elements 103. Image sensors 106a and 106b may be identical in terms of the pixel arrays (i.e., same number of pixels and same size of pixels). In operation, lens assembly 102 may focus incoming light 101 on beam splitter 114 as lensed light 123. Beam splitter 114 may split lensed light 123 and direct one image toward filter 115 and image sensor 106a (collectively, “luminance sensor 120”) and a substantially identical image toward filter 117 and image sensor 106b (collectively, “chrominance sensor 122”). Chrominance sensor 122 may be configured to sense a chrominance image 111 and a low quality luminance image 107. Image processing module 110 may combine chrominance image 111 and a high quality luminance image 109 to form a composite image 113. Image processing module 110 may also be configured to generate a low-quality luminance image 107, which may be useful for substantially aligning high-quality luminance image 109 with chrominance image 111.

Filter 115 may overlay image sensor 106a and allow image sensor 106a to capture the luminance portion of a sensed image, such as high-quality luminance image 109. Filter 117 may overlay image sensor 106b and allow image sensor 106b to capture the chrominance portion of a sensed image, such as chrominance image 111. The luminance portion of a color image can have a greater influence than the chrominance portion of a color image on the overall color image quality. High sample rates and high signal-to-noise ratios (“SNRs”) in the chrominance portion of the image may not be needed for a high quality color image.

In some embodiments, image sensor 106a may be configured without filter 115. Those skilled in the art will appreciate that an image sensor without a filter may receive substantially the full luminance of incoming light, which may allow for image sensor 106a to have a higher sampling rate, improved light efficiency, and/or sensitivity. For example, luminance sensor 120 may be configured to sense light at any wavelength and at substantially all pixel locations. In other embodiments, luminance sensor 106a may include filter 115, which attenuates light as necessary to produce a response from the sensor that matches the response of the human eye (i.e., the filter produces a weighting function that mimics the response of the human eye).

High-quality luminance image 109 may be a higher quality luminance image than low-quality image luminance image 111. The increased sensitivity of luminance sensor 109 afforded by sensing the full or substantially full luminance of an image may be used in various ways to extend the performance of image sensing device 100 and its composite image 113. For example, an image sensor with relatively small pixels may be configured to average the frames or operate at higher frame rates, which may cause the smaller pixels to perform like larger pixels. Noise levels may be reduced by using less analog and digital gain to improve image compression and image quality. Smaller lens apertures may be used to increase depth of field. Images may be captured in darker ambient lighting conditions. Alternatively or additionally, the effect of hot pixels may be reduced by using shorter exposure times.

According to some embodiments, chrominance sensor 122 may be configured to generate chrominance image 111 as a lower quality image without producing human-perceptible degradation of composite image 113, particularly if composite image 113 is compressed (e.g., JPEG compression). For example, chrominance sensor 122 may use a larger lens aperture or a lower frame rate than luminance sensor 120, which may improve operation at lower light levels (e.g., at lower intensity levels of incoming light 101). Similarly, chrominance sensor 122 may use shorter exposure times to reduce motion blur. Thus, the ability to control luminance sensor 120 separately from chrominance sensor 122 can extend the performance of image sensing device 100 in a variety of ways.

The luminance portion of an image may be defined as being approximately 30% detected red light, 60% detected green light, and 10% detected blue light, while the chrominance portion of an image may be defined as two signals or a two dimensional vector for each pixel of an image sensor. For example, the chrominance portion may be defined by two components Cr and Cb, where Cr may be detected red light less detected luminance and where Cb may be detected blue light less detected luminance. However, if luminance sensor 120 detects the luminance of incoming light 101, chrominance sensor 122 may be configured to detect red and blue light and not green light, for example, by covering pixel elements of sensor 106b with a red and blue filter 117. This may be done in a checkerboard pattern of red and blue filter portions. In other embodiments, filter 117 may include a Bayer-pattern filter array, which includes red, blue, and green filters. In some embodiments, chrominance sensor 120 may be configured with a higher density of red and blue pixels to improve the overall quality of composite image 213.

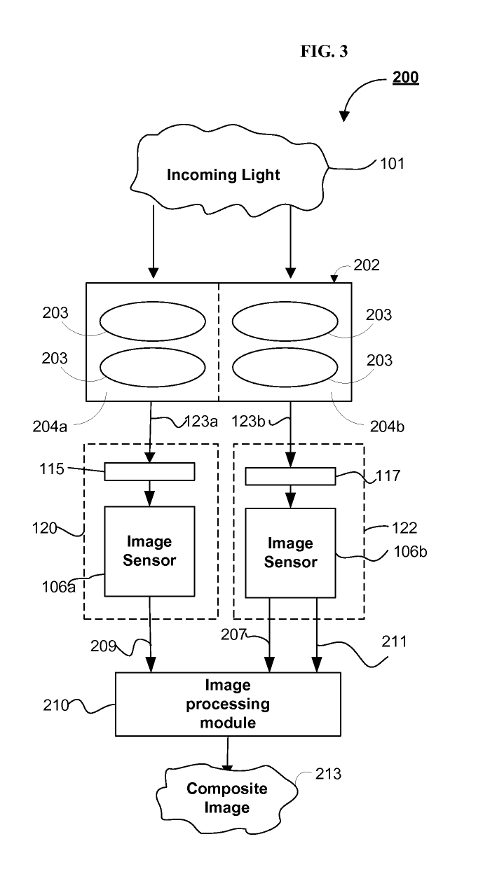

FIG. 3 is a functional block diagram of an exemplary image sensing device 200 with parallel lens trains according to some embodiments of the invention. Image sensing device 200 may include a lens assembly 202 having two parallel lens trains 204a and 204b, luminance sensor 120, chrominance sensor 122, and an image processing module 210. In the illustrated embodiment, parallel lens trains 204a and 204b of lens assembly 202 may be configured to receive incoming light 101 and focus lensed light 123a and 123b on luminance sensor 120 and chrominance sensor 122, as shown. Image processing module 210 may combine a high-quality luminance image 209 captured by and transmitted from luminance sensor 120 with a chrominance image 211 captured by and transmitted from chrominance sensor 122, and may output a composite image 213. In some embodiments, image processing module 210 may use a variety of techniques to account for differences between high-quality luminance image 209 and chrominance image 211, such as to form composite image 213.

An image sensing device may include a luminance sensor and a chrominance sensor mounted on separate integrated circuit chips. In some embodiments, not shown, an image sensing device may include three or more parallel lens trains and three or more respective image sensors, wherein each image sensor may be implemented on a separate integrated circuit chip of the device. In such embodiments, each of the image sensors may be configured to capture different color portions of incoming light passed by its respective parallel lens train. For example, a first lens train may pass light to an image sensor configured to capture only the red portion of the light, a second lens train may pass light to an image sensor configured to capture only the green portion of the light, and a third lens train may pass light to a third image sensor configured to capture only the blue portion of the light. The red captured portion, the green captured portion, and the blue captured portion could then be combined using an image processing module to create a composite image, as described with respect to device 200 of FIG. 3.

Lens assembly 202 may include a lens block with one or more separate lens elements 203 for each parallel lens train 204a and 204b. According to some embodiments, each lens element 203 of lens assembly 202 may be an aspheric lens and/or may be molded from the same molding cavity as the other corresponding lens element 203 in the opposite lens train. Using molded lenses (e.g., molded plastic lenses) from the same molding cavity in the corresponding position in each one of parallel lens trains 204 may be useful in minimizing generated image differences, such as geometric differences and radial light fall-off, if sensing the same incoming light. Within a particular lens train, however, one lens element may vary from another. In some embodiments, lens elements 203 may differ among lens trains. For example, one lens element may be configured with a larger aperture opening than the other element, such as to have a higher intensity of light on one sensor.

In some embodiments, image processing module 210 may compare high-quality luminance image 209 with low-quality luminance image 207. Based on this comparison, image processing module 210 may account for the differences between high-quality luminance image 209 and low-quality luminance image 207, such as to substantially aligned the image data to form composite image 213.

According to some embodiments, image processing module 210 may include a deliberate geometric distortion of at least one of high-quality luminance image 209 and low-quality luminance image 207, such as to compensate for depth of field effects or stereo effects. Some images captured by image sensing device 200 may have many simultaneous objects of interest at a variety of working distances from lens assembly 202. Alignment of high-quality luminance image 209 and low-quality luminance image 207 may therefore require the warping of one image using a particular warping function to match the other image if alignment is desired. For example, the warping function may be derived using high-quality luminance image 209 and low-quality luminance image 207, which may be substantially identical images except for depth of field effects and stereo effects. The algorithm for determining the warping function may be based on finding fiducials in high-quality luminance image 109 and low-quality luminance image 107 and then determining the distance between fiducials in the pixel array. Once the warping function has been determined, chrominance image 211 may be “warped” and combined with high-quality luminance image 209 to form composite image 213.

In other embodiments, image processing module 210 may be configured to align high-quality luminance image 209 and low-quality luminance image 207 by selectively cropping at least one of image 209 and 207 by identifying fiducials in its field of view or by using calibration data for image processing module 210. In other embodiments, image processing module 210 can deduce a working distance between various objects in the field of view by analyzing differences in high-quality luminance image 209 and low-quality luminance image 207. The image processing modules described herein may be configured to control image quality by optical implementation, by an algorithm, or by both optical implementation and algorithm.

In some embodiments, low-quality luminance image 207 may be of a lower quality than high-quality luminance image 209 if, for example, chrominance sensor 122 allocates some pixels to chrominance sensing rather than luminance sensing. In some embodiments, low-quality luminance image 207 and high-quality luminance image 209 may differ in terms of image characteristics. For example, low-quality luminance image 207 may be of a lower quality if chrominance sensor 122 has a larger lens aperture or lower frame rates than luminance sensor 120, which may improve operation at lower light levels (e.g., at lower intensity levels of incoming light 201). Similarly, chrominance sensor 122 may use shorter exposure times to reduce motion blur. Thus, the ability to control luminance sensor 120 separately from chrominance sensor 122 can extend the performance of image sensing device 200 in a variety of ways.

Image sensing device 100 of FIG. 2 may include a larger gap between its lens assembly (e.g., lens assembly 102) and its image sensors (e.g., sensors 106a and 106b) due to beam splitter 114 than between the lens assembly and image sensor found in a device with a single image sensor. Moreover, although splitter 114 may split the optical power of lensed light 123 before it is captured by image sensors 106a and 106b, this configuration of an image sensing device allows for substantially identical images to be formed at each image sensor. On the other hand, image sensing device 200 of FIG. 3 may include a gap between its lens assembly (e.g., lens assembly 202) and its image sensors (e.g., sensors 106a and 106b) that is the same thickness as or thinner than the gap found between the lens assembly and image sensor of a device with a single image sensor. Furthermore, the optical power of lensed light 123 will not be split before it is captured by image sensors 106a and 106b.

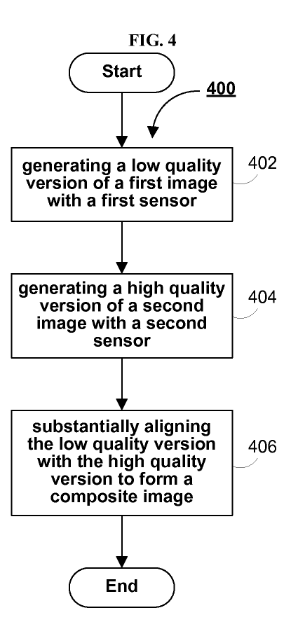

FIG. 4 is a process diagram of an exemplary method 400 for capturing an image using separate luminance and chrominance sensors according to some embodiments of the invention. At step 402, incoming light may be captured as a low quality image by a image sensor, which may be configured to capture just the chrominance portion of the incoming light or both the chrominance portion and the luminance portion of the incoming light. At step 404, incoming light may be captured as a high quality image by an image sensor, which may be configured to capture just the luminance portion of the incoming light. At step 406, the low quality chrominance image may be combined with the high quality luminance image to form a composite image. In some embodiments, combining the images may include substantially aligning the images using techniques such as geometric distortion and image cropping. A luminance portion of the low quality image may be compared with the luminance portion of the high quality image in order to determine a proper warping function needed to properly combine the two images for forming the composite image.

While the systems and methods for aligning images have been described in connection with a parallel lens train embodiment, the described systems and methods are also applicable to other embodiments of an image sensing device, including image sensing device 100 of FIG. 2.

The order of execution or performance of the methods illustrated and described herein is not essential, unless otherwise specified. That is, elements of the methods may be performed in any order, unless otherwise specified, and that the methods may include more or less elements than those disclosed herein. For example, it is contemplated that executing or performing a particular element before, contemporaneously with, or after another element is within the scope of the invention.

One of ordinary skill in the art should appreciate that the invention may take the form of an entirely hardware embodiment or an embodiment containing both hardware and software elements. In particular embodiments, such as those embodiments that relate to methods, the invention may be implemented in software including, but not limited to, firmware, resident software, and microcode.

One of ordinary skill in the art should appreciate that the methods and systems of the invention may be practiced in embodiments other than those described herein. It will be understood that the foregoing is only illustrative of the principles disclosed herein, and that various modifications can be made by those skilled in the art without departing from the scope and spirit of the invention or inventions.

What is claimed is:

1. An image sensing device comprising:
a lens train for sensing an image;
a beam splitter for splitting the image sensed by the lens train into a first split image and a second split image;
a first image sensor for capturing a luminance portion of the first split image;
a second image sensor for capturing a chrominance portion of the second split image; and
an image processing module for combining the luminance portion and the chrominance portion to form a composite image.

2. The image sensing device of claim 1, wherein the second image sensor has a frame rate that is lower than a frame rate of the first image sensor.

3. The image sensing device of claim 1, wherein the first image sensor is configured to be controlled separately from the second image sensor.

4. The image sensing device of claim 1, wherein the first image sensor is formed on a first integrated circuit chip, and wherein the second image sensor is formed on a second integrated circuit chip.

5. The image sensing device of claim 1, wherein the first image sensor is configured to sense light at any wavelength.

6. The image sensing device of claim 1, wherein the first image sensor is configured to sense light at substantially all pixel locations.

7. An image sensing device comprising:
a first image sensor for capturing a first image;
a second image sensor for capturing a second image; and
an image processing module for combining the first image captured by the first image sensor and the second image captured by the second image sensor to form a composite image.

8. The image sensing device of claim 7, wherein the second image sensor has an aperture opening larger than an aperture opening of the first image sensor.

9. The image sensing device of claim 7, wherein a chrominance portion of the composite image is determined based on a red portion of the second image, a blue portion of the second image, and the first image.

10. The image sensing device of claim 7, wherein the second sensor includes a pattern of red and blue filters.

11. The image sensing device of claim 7, wherein the second image sensor includes a Bayer-pattern filter.

12. The image sensing device of claim 7, further comprising:
a first lens train for focusing incoming light on the first image sensor, wherein the first lens train includes a molded aspheric lens element.

13. The image sensing device of claim 12, further comprising:
a second lens train for focusing the incoming light on the second image sensor, wherein the first lens train and the second lens train have different apertures.

14. The image sensing device of claim 7, wherein the first image is a high-quality luminance image, and wherein second image is a chrominance image, and wherein the second image sensor is configured to capture a low-quality luminance sensor.

15. The image sensing device of claim 14, wherein the image processing module is configured to substantially align the high-quality luminance image and the chrominance image.

16. The image sensing device of claim 14, wherein the image processing module is configured to determine a warping function based on differences between the high-quality luminance image and the low-quality luminance image.

17. The image sensing device of claim 16, wherein the image processing module is configured to substantially align the high-quality luminance image and the chrominance image based on the warping function.

18. The image sensing device of claim 7, wherein the first image sensor is a higher megapixel sensor than the second image sensor.

19. The image sensing device of claim 7, wherein the second image sensor is a higher megapixel sensor than the first image sensor.

20. A method of operating an image sensing device comprising:
generating a high-quality luminance image with a first sensor;
generating a chrominance image with the second sensor; and
substantially aligning the high-quality luminance image with the chrominance image to form a composite image.

21. The method of claim 20, further comprising:
generating a low-quality luminance image with a second sensor, wherein alignment of the high-quality luminance image with the chrominance image is based on the low-quality luminance image.

22. The method of claim 21, wherein substantially aligning comprises selectively cropping at least one of the low-quality luminance image and the high quality luminance image.

23. The method of claim 20, wherein substantially aligning comprises warping the chrominance image.

24. The method of claim 20, wherein substantially aligning comprises deliberate geometric distortion.

25. An image sensing device comprising:
a first lens train for sensing a first image;
a second lens train for sensing a second image;
a third lens train for sensing a third image;
a red image sensor for capturing the red portion of the first image;
a green image sensor for capturing the green portion of the second image;
a blue image sensor for capturing the blue portion of the third image; and
an image processing module for combining the red portion, the green portion, and the blue portion to form a composite image.

26. The image sensing device of claim 25, wherein each one of the red image sensor, the green image sensor, and the blue image sensor is mounted on a separate integrated circuit chip.
